(19) United States
(12) Patent Application Publication
(10) Pub. No.: US 2021/0066696 A1
(43) Pub. Date: Mar. 4, 2021

(54) BATTERY WIRING MODULE

(71) Applicant: Sumitomo Wiring Systems, Ltd., Mie (JP)

(72) Inventors: Hiroshi SATO, Mie (JP); Ryota MORI, Mie (JP); Hisayoshi YAITA, Mie (JP); Masami SUZUKI, Mie (JP); Maya NAKASUKA, Mie (JP)

(73) Assignee: Sumitomo Wiring Systems, Ltd., Mie (JP)

(21) Appl. No.: 16/991,631

(22) Filed: Aug. 12, 2020

(30) Foreign Application Priority Data
Aug. 29, 2019 (JP) 2019-156336

(51) Int. Cl. H01M 2/20

(52) U.S. Cl. CPC H01M 2/206

(57) ABSTRACT

The present disclosure aims to provide a battery wiring module according to which it is possible to easily inspect erroneous assembly resulting from rising of wires. A housing of the battery storage module includes a wire storage groove that contains wires and a cover member that covers the wire storage groove. The wire storages groove includes a bottom wall, side walls that stand upright from the bottom wall and oppose each other, and a protruding portion that protrude from a side wall toward an opposing side wall. The cover member includes a through hole that opposes the protruding portion from a side opposite to the bottom wall.

### TECHNICAL FIELD

The present invention relates to a battery wiring module.

### BACKGROUND ART

A battery in which multiple battery cells are aligned in series or in parallel is mounted as, for example, a travel drive power source in a vehicle such as an electric automobile or a hybrid automobile. As disclosed in JP 2018-195504A, a battery wiring module that stores wire terminals connected to multiple bus bars that connect battery terminals of adjacent battery cells and multiple wires each having one end side to which a wire terminal is connected is mounted on the battery. The battery wiring module includes groove-shaped wire storage grooves that store the wires. Also, protruding portions that protrude from the inner surfaces of the side walls of the wire storage grooves to the inner portions of the grooves are provided. The protruding portions partially cover the wires stored in the wire storage grooves and suppress rising of the wires. Also, the battery wiring module includes cover members that cover the wire storage grooves and hang over the protruding portions.

JP 2018-195504A is an example of related art.

Incidentally, in the above-described battery wiring module, after the wire storage grooves are covered by the cover members, even if the wires rise from the wire storage grooves past the protruding portions, it is difficult to inspect whether or not the wires have risen from outside of the cover members. For this reason, there is a risk that the wires will be erroneously assembled in a risen state, and thus there has been room for improvement in this regard.

The present disclosure aims to provide a battery wiring module according to which it is possible to easily inspect erroneous assembly resulting from rising of the wires.

### SUMMARY OF THE INVENTION

A battery wiring module according to the present disclosure includes: a plurality of wire terminals that are respectively connected to a plurality of bus bars that connect battery terminals of a plurality of battery cells; a plurality of wires that are respectively connected to the plurality of wire terminals; and a housing storing the plurality of wire terminals and the plurality of wires. The housing includes a wire storage groove for storing the wires and a cover member for covering the wire storage groove. The wire storage groove includes a bottom wall, side walls that stand upright from the bottom wall and oppose each other, and a protruding portion that protrudes from a side wall toward an opposing side wall. The wire storage groove stores the wires on the bottom wall side relative to the protruding portion inside of the wire storage groove. The cover member has a through hole that opposes the protruding portion from a side opposite to the bottom wall.

According to the present disclosure, it is possible to provide a battery wiring module according to which it is possible to easily inspect erroneous assembly resulting from rising of the wires.

### BRIEF DESCRIPTION OF THE DRAWINGS

FIG. 1 is a top view of a battery wiring module in a state of being attached to a secondary battery in one embodiment.

FIG. 2 is a top view of a housing near a protruding portion in the embodiment.

FIG. 3 is a cross-sectional view taken along line I-I in FIG. 2.

### EMBODIMENTS OF THE INVENTION

### Description of the Embodiments of the Disclosure

First, embodiments of the present disclosure will be listed and described.

A battery wiring module according to the present disclosure includes:

[1] a plurality of wire terminals that are respectively connected to a plurality of bus bars that connect battery terminals of a plurality of battery cells; a plurality of wires that are respectively connected to the plurality of wire terminals; and a housing storing the plurality of wire terminals and the plurality of wires. The housing includes a wire storage groove for storing the wires and a cover member for covering the wire storage groove. The wire storage groove includes a bottom wall, side walls that stand upright from the bottom wall and oppose each other, and a protruding portion that protrudes from a side wall toward an opposing side wall. The wire storage groove stores the wires on the bottom wall side relative to the protruding portion inside of the wire storage groove. The cover member has a through hole that opposes the protruding portion from a side opposite to the bottom wall.

According to the above-described aspect, the protruding portion can be viewed from the outside of the housing via the through hole. Accordingly, it is possible to view from the outside whether or not there is a wire that has risen from a wire storage groove past the protruding portion. For this reason, it is possible to easily inspect erroneous assembly resulting from rising of the wires.

[2] It is preferable that the protruding portion includes a first protruding portion that is provided on one of the side walls that are paired, and a second protruding portion that is provided on the other side wall, and the first protruding portion and the second protruding portion oppose each other.

According to the above-described aspect, rising of the wires can be suitably suppressed by the first protruding portion and the second protruding portion, which oppose each other.

[3] It is preferable that the first protruding portion protrudes from the side wall past the center between the side walls that are paired.

According to the above-described aspect, the first protruding portion can be provided over a long distance extending past the center between the side walls in the direction in which the side walls oppose each other, and therefore the wires are less likely to rise past the first protruding portion. Accordingly, the rising of the wires can be suitably suppressed.

[4] It is preferable that the first protruding portion and the second protruding portion are provided with a gap therebetween.

According to the above-described aspect, the wires can be arranged in the wire storage groove via the gap between the first protruding portion and the second protruding portion. This can contribute to an improvement in assemblability.

[5] It is preferable that the through hole opposes the first protruding portion, the second protruding portion, and the gap.

According to the above-described aspect, the first protruding portion and the second protruding portion can be viewed via the through hole, and the interior of the wire storage groove can be viewed via the gap between the first protruding portion and the second protruding portion. Accordingly, it is possible to suitably view whether or not there is rising of the wires.

[6] It is preferable that the protruding portion includes a lower surface that faces the bottom wall side and an upper surface on a side opposite to the lower surface, and the protruding portion has an inclined surface that is inclined toward the bottom wall side on the upper surface of a distal end portion protruding from the side wall.

According to the above-described aspect, the wires can be easily arranged toward the bottom wall with respect to the protruding portion, along the inclination of the inclined surface. This can contribute to an improvement in assemblability.

### Detailed Description of the Embodiments of the Disclosure

Hereinafter, a specific example of a battery wiring module of the present disclosure will be described with reference to the drawings below. Note that the present disclosure is not limited to these illustrative examples but is indicated by the scope of the claims, and all modifications that fall within the meaning and range of equivalency to the scope of the claims are intended to be encompassed therein.

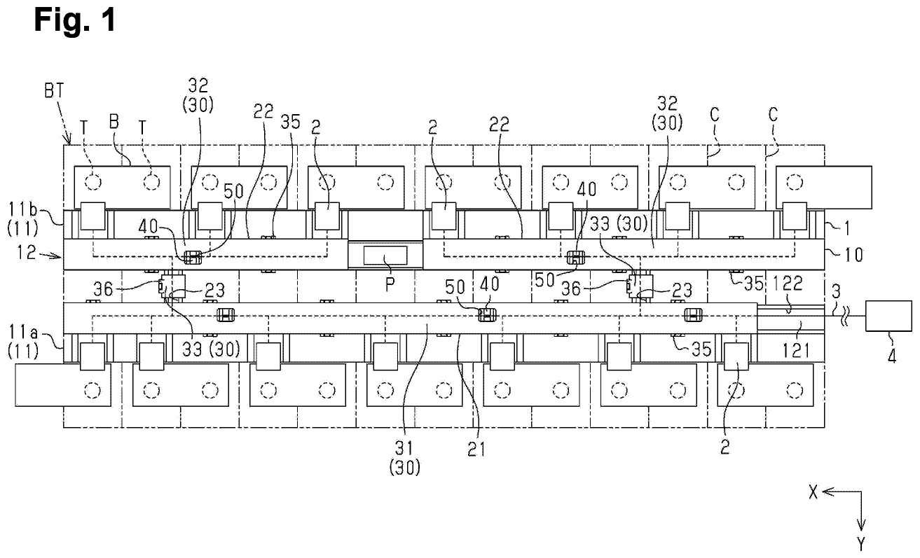

As shown in FIG. 1, the battery wiring module 1 is mounted on an approximately cuboid-shaped secondary battery BT. The secondary battery BT is mounted in an electric automobile, a hybrid automobile, or the like. Also, the secondary battery BT supplies power to a travel motor of the vehicle and receives a supply of power from the travel motor and a power generation motor in response to a charging state or a driving state of the vehicle. The secondary battery BT includes multiple battery cells C that are arranged side by side in one direction. In the following description, in the battery wiring module 1, the direction along the direction in which the battery cells C are arranged side by side is the X direction, and the direction orthogonal to the X direction is the Y direction in a state in which the battery wiring module 1 is mounted on the secondary battery BT. Also, the direction orthogonal to the X direction and the Y direction is the up-down direction, and the side of the secondary battery BT on which the battery wiring module 1 is mounted is the upper side.

The battery cells C each include two battery terminals T. One of the two battery terminals is a cathode-side terminal and the other is an anode-side terminal. When the battery cells C are arranged side by side in the X direction, the two battery terminals T are arranged side by side in the Y direction on the surface opposing the battery wiring module 1, that is, the upper surface. At this time, the battery cells C are arranged side by side with the orientations of the battery cells alternatingly reversed such that the cathode-side battery terminals T and the anode-side battery terminals T are arranged side by side alternatingly in the arrangement direction, that is, the X direction. Accordingly, two rows of the battery terminals T in which the cathode sides and the anode sides are arranged side by side alternatingly are formed.

Multiple bus bars B that electrically connect the battery terminals T are provided on the secondary battery BT. Each bus bar B connects battery terminals T that are adjacent to each other, that is, a cathode-side battery terminal T and an anode-side battery terminal T. The multiple bus bars B electrically connect the multiple battery terminals T in series. The bus bars B of the present example are connected through welding to the battery terminals T, for example. The bus bars B form a group of bus bars B that are arranged on one side in the Y direction, and a group of bus bars B that are arranged on another side in the Y direction. These groups correspond to the rows of the battery terminals T that are arranged side by side in two rows. Note that in the multiple battery cells C connected in series, the bus bars B provided on the positive and negative battery terminals T on the two ends are drawn to the outside and connect the battery terminals T with an external apparatus.

The battery wiring module 1 includes multiple wire terminals 2 that are respectively connected to the multiple bus bars B, and multiple wires 3 that are respectively connected to the multiple wire terminals 2. The wire terminals 2 and the wires 3 are for voltage detection for detecting the voltages of the bus bars B, for example. The wires 3 each have one end connected to a wire terminal 2, and another end connected to a connector 4 for connecting to a voltage detection apparatus. The battery wiring module 1 is provided between the above-described two groups of the bus bars B. Note that in the drawings, the wires 3 are not illustrated, and FIG. 1 schematically shows paths through which the wires 3 pass.

The battery wiring module 1 includes a housing 10 made of an insulating resin. The housing 10 has an elongated shape that has a length direction in the X direction and has a width direction in the Y direction, for example. The housing 10 includes terminal storage portions 11 for storing the wire terminals 2, and wire storage grooves 12 for storing the wires 3.

In the housing 10, the terminal storage portions 11 include terminal storage portions 11a that are provided on one side in the Y direction and terminal storage portions 11b that are provided on the other side. The terminal storage portions 11a and the terminal storage portions 11b extend in the X direction and are arranged adjacent to different groups of the bus bars B. The terminal storage portions 11 store multiple wire terminals 2 such that they are arranged side by side in the X direction. That is, the wire terminals 2 are arranged side by side in the X direction. The wire terminals 2 are stored such that portions thereof protrude outward in the Y direction from the terminal storage portions 11 and the protruding portions are connected to the bus bars B.

The wire storage grooves 12 are arranged between the terminal storage portions 11a and the terminal storage portions 11b in the Y direction. The wire storage grooves 12 each include a bottom wall 121 and a pair of side walls 122 that stand upright from the bottom wall 121 and oppose each other. Hereinafter, when the side walls 122 that are paired are described, both of the side walls 122 that oppose each other with the bottom wall 121 interposed therebetween will be referred to. When mounted on the secondary battery BT, the bottom wall 121 opposes the secondary battery BT, and the side of the wire storage grooves 12 opposite to the bottom wall 121, that is, the upper side, is open.

The wire storage grooves 12 include a first storage groove 21, second storage grooves 22, and third storage grooves 23. The first storage groove 21 and the second storage grooves 22 both extend in the X direction and are arranged side by side with each other in the Y direction. The side walls 122 that are paired oppose each other in the Y direction in the first storage groove 21 and the second storage grooves 22. The third storage grooves 23 are provided between the first storage groove 21 and the second storage grooves 22 and extend in the Y direction.

The first storage groove 21 is provided on one side in the Y direction so as to be adjacent to the terminal storage portions 11a. One first storage groove 21 is provided over the entire length in the X direction in the housing 10. All of the wires 3 are drawn out from one end in the X direction of the first storage groove 21. The wires 3 are connected to the connector 4 by the ends drawn out from the first storage groove 21.

The second storage grooves 22 are provided on the other side in the Y direction so as to be adjacent to the terminal storage portions 11b. Two second storage grooves 22 of the present embodiment are provided and are both arranged side by side linearly in the X direction. For example, a part attachment portion P is provided in the space between the two second storage grooves 22. One example of a part that is attached at the part attachment portion P is a thermistor.

The first storage groove 21 and the second storage grooves 22 are spaced apart from each other in the Y direction. Here, the first storage groove 21 and the second storage grooves 22 are spaced apart from each other in the Y direction in order to, for example, provide a space for providing another member in the central portion of the secondary battery BT in the Y direction, or for providing a clearance between the first storage groove 21 and second storage grooves 22 and the other member. One example of another member is an explosion-proof valve.

The third storage grooves 23 are in communication with the first storage groove 21 and the second storage grooves 22. Two third storage grooves 23, namely one third storage groove 23 that is provided between the first storage groove 21 and the second storage groove 22 on one side in the X direction, and another third storage groove 23 that is provided between the first storage groove 21 and the second storage groove 22 on the other side in the X direction, are provided. The first storage groove 21 and the second storage groove 22 on one side in the X direction are in communication with each other through the one third storage groove 23, and the first storage groove 21 and the second storage groove 22 on the other side in the X direction are in communication with each other through the other third storage groove 23. The wires 3 are passed between the first storage groove 21 and the second storage grooves 22 via these third storage grooves 23. That is, a portion of the multiple wires 3 is arranged from the first storage groove 21 to the second storage groove 22 on the one side in the X direction through the one third storage groove 23. Also, another portion of the multiple wires 3 is arranged from the first storage groove 21 to the second storage groove 22 on the other side in the X direction through the other third storage groove 23. Note that the third storage grooves 23 are each preferably arranged so as not to interfere with the other member provided in the above-described central portion of the secondary battery BT, for example.

The housing 10 includes cover members 30 that cover the wire storage grooves 12. The cover members 30 include a first cover 31 that covers the first storage groove 21, two second covers 32 that respectively cover the two second storage grooves 22, and third covers 33 that cover the third storage grooves 23. The first cover 31 and the second covers 32 are provided separately from the first storage groove 21 and the second storage grooves 22. The third covers 33 are hinge covers that are joined to the third storage grooves 23 via hinges, and are provided in one piece with the third storage grooves 23.

The first cover 31 and the second covers 32 engage with the first storage groove 21 and the second storage grooves 22 through multiple engaging portions 35 provided on their peripheral edges, for example. The third covers 33 engage in a state of covering the third storage grooves 23 using engaging portions 36 provided on the peripheral edges on the sides opposite to the hinges, for example.

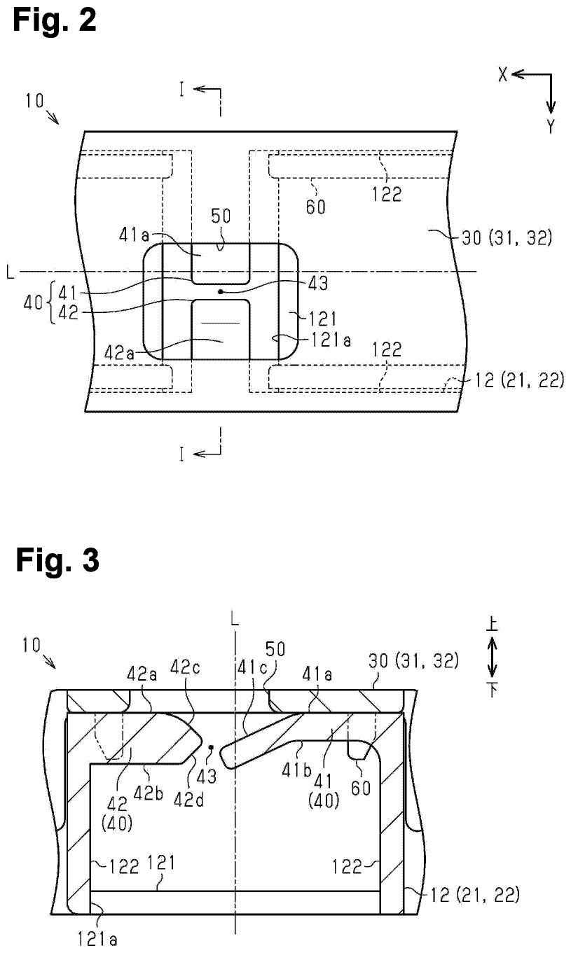

As shown in FIGS. 2 and 3, the wire storage groove 12 includes protruding portions 40 that each protrude from a side wall 122 toward an opposing side wall 122. Multiple protruding portions 40 are provided in the first storage groove 21 and the second storage grooves 22. In the first storage groove 21 and the second storage grooves 22, the protruding portions 40 protrude in the Y direction, which is the direction in which the side walls 122 that are paired oppose each other. The protruding portions 40 are provided on upper end portions spaced apart from the bottom wall 121 on the side walls 122 of the wire storage grooves 12. The protruding portions 40 include a first protruding portion 41 that is provided on one of the side walls 122 that are paired and oppose each other, and a second protruding portion 42 that is provided on the other side wall 122. The first protruding portion 41 and the second protruding portion 42 oppose each other. Also, opening portions 121a are formed in the portions of the bottom wall 121 of the wire storage grooves 12 that opposes the protruding portions 40.

The pair consisting of the first protruding portion 41 and the second protruding portion 42 is provided so as to have a gap 43 between the first protruding portion 41 and the second protruding portion 42. Also, if a plane that passes through the center between the side walls 122 that are paired and oppose each other and that extends along the side walls 122 is defined as a virtual plane L, the first protruding portion 41 protrudes from the side wall 122 toward the opposing side wall 122 past the virtual plane L. The virtual plane L corresponds to the center between the side walls 122 that are paired. The first protruding portion 41 has a longer protrusion length than the second protruding portion 42.

The first protruding portion 41 has a lower surface 41b that faces the bottom wall 121, and an upper surface 41a on the side opposite to the lower surface 41b. The first protruding portion 41 has an inclined surface 41c that is inclined downward in the Y direction on the upper surface 41a of the distal end portion protruding from the side wall 122. That is, the upper surface 41a is inclined at the distal end portion of the first protruding portion 41. The distal end portion of the first protruding portion 41 is inclined downward along the inclined surface 41c. The first protruding portion 41 is provided thinner than the second protruding portion 42 in the up-down direction and can bend in the up-down direction.

The second protruding portion 42 has a lower surface 42b that faces the bottom wall 121 and an upper surface 42a on the side opposite to the lower surface 42b. The second protruding portion 42 has an inclined surface 42c that is inclined downward in the Y direction on the upper surface 42a of the distal end portion protruding from the side wall 122. Also, the second protruding portion 42 includes an inclined surface 42d that is inclined upward with respect to the Y direction on the lower surface 42b of the distal end portion. That is, the distal end portion of the second protruding portion 42 is formed into a tapered shape in the up-down direction. The gap 43 widens downward from at least the narrowest portion, along the inclined surface 42d provided on the lower surface 42b of the second protruding portion 42.

In the case of the present embodiment, in the first storage groove 21, the first protruding portion 41 of the protruding portions 40 is arranged on one side in the Y direction, and the second protruding portion 42 is arranged on the other side in the Y direction. In the second storage groove 22, the first protruding portion 41 of the protruding portions 40 is arranged on the other side in the Y direction, and the second protruding portion 42 is arranged on the one side in the Y direction. That is, the first protruding portions 41 are provided on the outer side walls 122, which are located on the terminal storage portion 11 side of the pairs of side walls 122 of the wire storage grooves 12.

The cover members 30 have through holes 50 that are formed in the up-down direction through the surfaces of the cover members 30 that cover the wire storage grooves 12. The through holes 50 are provided above the protruding portions 40 in the first cover 31 and the second covers 32. The through holes 50 oppose the upper surfaces 41a of the first protruding portions 41 and the upper surfaces 42a of the second protruding portions 42 and oppose the gaps 43. Also, the length in the X direction of each of the through holes 50 is set to be longer than that of each of the first protruding portion 41 and the second protruding portions 42. Also, the center in the Y direction of each through hole 50 is shifted toward the inner side wall 122 away from the terminal storage portions 11 among the pairs of side walls 122 with respect to the virtual planes L.

Ribs 60 that protrude downward are formed on the first cover 31 and the second covers 32. The ribs 60 are provided on both the one side and the other side in the Y direction on the first cover 31 and the second covers 32. The ribs 60 loosely fit into the inner surfaces of the side walls 122 of the wire storage grooves 12. Note that although the positions in the up-down direction of the ribs 60 overlap with the protruding portions 40, notches are formed at the positions of the protruding portions 40 such that the ribs 60 and the protruding portions 40 do not interfere with each other. The notches of the ribs 60 function to position the first cover 31 and the second covers 32 with respect to the wire storage grooves 12. Accordingly, when the first cover 31 and the second covers 32 are attached to the wire storage grooves 12, the positions of the protruding portions 40 and the through holes 50 match.

Operations of the present embodiment will be described next. The wires 3 are arranged in the wire storage grooves 12 in a state in which the cover members 30 have been removed. When the wires 3 are arranged in the wire storage grooves 12, the wires 3 are arranged through the gaps 43 between the first protruding portions 41 and the second protruding portions 42. Also, by pushing down the distal end portions of the first protruding portions 41, the first protruding portions 41 can be bent and the gaps 43 between the first protruding portions 41 and the second protruding portions 42 can be widened by pressing. Furthermore, since the inclined surfaces 41c and the inclined surfaces 42c are provided on the distal end portions of the first protruding portions 41 and the second protruding portions 42, the wires 3 can be guided to the gaps 43 by the inclinations. The wires 3 are guided to the gaps 43 along the inclinations and are arranged in the wire storage grooves 12 through the gaps 43 widened by pressing.

The wires 3 are arranged between the bottom wall 121 and the protruding portions 40 in the wire storage grooves 12, and thus rising is suppressed by the protruding portions 40. Here, the wires 3 are arranged bent in the first storage groove 21, the second storage grooves 22, and the third storage grooves 23 when arranged in the wire storage grooves 12. At this time, due to curling of the wires 3 and the like, the wires 3 tend to deviate toward the side walls 122 located on the terminal storage portion 11 side, that is, toward the outer side, in the wire storage grooves 12. In the case of the present embodiment, the first protruding portion 41 that is longer than the second protruding portion 42 is provided on the side walls 122 on the outer side. The first protruding portions 41 protrude from the outer side walls 122 to the inner side walls 122, past the virtual planes L passing through the centers between the pairs of side walls 122. Accordingly, the gaps 43 between the first protruding portions 41 and the second protruding portions 42 are located toward the inner side walls 122 opposing the outer side walls 122. Accordingly, the distances between the paths through which the multiple wires 3 pass and the gaps 43 increase in the wire storage grooves 12. As a result, a case is suppressed in which the wires 3 rise past the protruding portions 40 via the gaps 43. Also, the centers in the Y direction of the through holes 50 are shifted toward the inner side walls 122, that is, toward the gaps 43, with respect to the virtual plane L. For this reason, if the through holes 50 are provided so as to oppose the gaps 43, the through holes 50 can be made smaller.

After the wires 3 are arranged, the cover members 30 are attached to the battery wiring module 1. The through holes 50 opposing the first protruding portions 41, the second protruding portions 42, and the gaps 43 are provided in the cover members 30. For this reason, after the cover members 30 are attached, the first protruding portions 41, the second protruding portions 42, and the gaps 43 can be viewed from the outside of the cover members 30 through the through holes 50. Accordingly, it is possible to inspect whether or not the wires 3 have risen from the wire storage grooves 12 past the protruding portions 40 by eyesight via the through holes 50. Also, it is possible to view the interiors of the wire storage grooves 12 via the gaps 43 through the through holes 50.

If a wire 3 rises past the protruding portions 40, the wire 3 is guided to the gaps 43 by the inclined surfaces 41c of the first protruding portions 41 and the inclined surfaces 42c of the second protruding portions 42, and therefore is likely to remain near the gaps 43 above the protruding portions 40. In the case of the present embodiment, the vicinity of the gaps 43 can be viewed, and therefore it is easy to check whether or not the wires 3 have risen.

Effects of the present embodiment will be described next.

(1) The housing 10 of the battery wiring module 1 includes the wire storage grooves 12 storing the wires 3, and the cover members 30 that cover the wire storage grooves 12. The wire storage grooves 12 each include the bottom wall 121 and the side walls 122 that oppose each other. The wire storage grooves 12 have the protruding portions 40 that each protrude from a side wall 122 toward an opposing side wall 122. The cover members 30 include the through holes 50 that oppose the protruding portions 40 from the side opposite to the bottom wall 121. Accordingly, the protruding portions 40 can be viewed from the outside of the housing 10 via the through holes 50. Accordingly, it is possible to view from the outside whether or not there is a wire 3 that has risen from the wire storage grooves 12 past the protruding portions 40. For this reason, it is possible to easily inspect erroneous assembly resulting from rising of the wires 3.

(2) The protruding portions 40 include the first protruding portion 41 that is provided on one of the side walls 122 that are paired, and the second protruding portion 42 that is provided on the side wall 122 on the other side, and the first protruding portion 41 and the second protruding portion 42 oppose each other. Accordingly, the rising of the wires 3 can be suitably suppressed by the the first protruding portion 41 and the second protruding portion 42 that oppose each other.

(3) If the plane extending through the center between the side walls 122 that are paired and along the side walls 122 is defined as the virtual plane L, the first protruding portion 41 extends from a side wall 122 past the virtual plane L. Accordingly, the first protruding portion 41 can be provided over a long distance extending past the virtual plane L in the direction in which the side walls 122 that are paired oppose each other, and therefore the wires 3 are less likely to rise past the first extended portion 41. As a result, the rising of the wires 3 can be suitably suppressed.

(4) The first protruding portion 41 and the second protruding portion 42 are provided so as to include the gap 43 therebetween. Accordingly, the wires 3 can be arranged in the wire storage grooves 12 via the gaps 43 between the first protruding portions 41 and the second protruding portions 42. This can contribute to an improvement in assemblability.

(5) The through holes 50 oppose the first protruding portions 41, the second protruding portions 42, and the gaps 43. Accordingly, the first protruding portions 41 and the second protruding portions 42 can be viewed via the through holes 50 and the interiors of the wire storage grooves 12 can be viewed via the gaps 43 between the first protruding portions 41 and the second protruding portions 42. Accordingly, it is possible to suitably view whether or not there is rising of the wires 3.

(6) The protruding portions 40 include the lower surfaces 41b and 42b that face the bottom wall 121 and the upper surfaces 41a and 42a on the side opposite to the lower surfaces 41b and 42b. The protruding portions 40 include the inclined surfaces 41c and 42c that are inclined downward with respect to the direction in which the side walls 122 that are paired oppose each other, on the upper surfaces 41a and 42a of the distal ends protruding from the side walls 122. Accordingly, the wires 3 can be easily arranged toward the bottom wall 121 relative to the protruding portions 40 along the inclinations of the inclined surfaces 41c and 42c. This can contribute to an improvement in assemblability.

The present embodiment can be implemented with the following modifications. The present embodiment and the following modified examples can be implemented in combination with each other so long as there are no technical discrepancies.

The inclined surfaces 41c and 42c may also be provided at the distal end portions of the first protruding portion 41 and the second protruding portion 42, and may also be provided on the entireties thereof. Also, there is no limitation to providing the inclined surfaces 41c and 42c on both the first protruding portion 41 and the second protruding portion 42, and the inclined surfaces 41c and 42c may also be provided on only one of the first protruding portion 41 and the second protruding portion 42. Furthermore, the inclined surfaces 41c and 42c may also be omitted.

The distal end portion of the first protruding portion 41 may also be inclined downward, and may also have a tapered shape. That is, an inclined surface that is inclined upward may also be provided on the lower surface 41b of the first protruding portions 41.

The distal end portion of the second protruding portion 42 may also be inclined downward, and may also have a tapered shape. That is, the inclined surface 42d of the second protruding portion 42 may also be omitted.

The through hole 50 is not limited to the above-described embodiment, and need only oppose the protruding portions 40. That is, the through hole 50 need only oppose one of the first protruding portion 41 and the second protruding portion 42, and opposing the gap 43 can be omitted from the constituent elements. Also, the length in the X direction of the through hole 50 may be longer than, shorter than, or the same as that of the protruding portions 40.

The first protruding portion 41 and the second protruding portion 42 may also be provided so as to be in contact with each other. That is, the gaps 43 may also be omitted. In this case, the wires 3 need only be arranged through the space obtained by spacing apart the first protruding portion 41 and the second protruding portion 42 by bending the first protruding portion 41.

The first protruding portion 41 may also be provided so as not to bend, and may be provided with the same thickness as the second protruding portion 42, for example. The second protruding portion 42 may also be provided so as to be bendable.

The widths in the X direction of the first protruding portion 41 and the second protruding portion 42 may also be the same as or different from each other. Also, the above-described widths are not particularly limited and can be changed as appropriate.

The first protruding portions 41, which are provided so as to protrude over a long distance, may also be provided on the outer side walls 122, the inner side walls 122, or a combination of both. The second protruding portions 42, which have shorter protrusion lengths than the first protruding portions 41 may also be provided on the outer side walls 122, on the inner side walls 122, or on a combination of both.

The first protruding portion 41 and the second protruding portion 42 may also have the same protrusion length. That is, the first protruding portion 41 being provided over a longer distance may also be omitted. Also, the first protruding portion 41 and the second protruding portion 42 may also have the same shape as each other.

The protruding portions 40 may also be provided on only one of the side walls 122 that are paired. That is, the protruding portions 40 are not limited to being provided on both of the side walls 122 that are paired.

The protruding portions 40 may also be provided in the first storage groove 21, the second storage grooves 22, the third storage grooves 23, or a combination thereof. Also, the numbers of the storage grooves and the protruding portions 40 provided in the entirety of the wire storage grooves 12 are not particularly limited.

The through holes 50 may also be provided on the first cover 31, the second covers 32, the third covers 33, or a combination thereof. Also, the numbers of the covers and the through holes 50 provided in the entireties of the cover members 30 are not particularly limited.

The third covers 33 may also be provided separately from the third storage grooves 23. That is, the third covers 33 are not limited to hinge covers.

The first cover 31 may also be provided in one piece with the first storage groove 21. The second covers 32 may also be provided in one piece with the second storage grooves 22. For example, the first cover 31 and the second covers 32 may also be hinge covers. That is, the first cover 31 and the second covers 32 are not limited to being provided separately from the wire storage grooves 12.

The wire storage grooves 12 are not limited to the above-described embodiment. For example, the first storage groove 21 may also be provided divided into multiple first storage grooves 21, and two or three or more first storage grooves 21 may also be provided in a divided manner. In this case, the multiple first storage grooves 21 may also be provided arranged side by side linearly in the X direction. That is, there is no limitation to only one first storage groove 21 being provided over the entire length in the X direction in the housing 10. In addition, only one second storage groove 22 may also be provided over the entire length in the housing 10. That is, there is no limitation to providing multiple second storage grooves 22 in the X direction. Furthermore, the wires 3 may also be drawn out from the second storage groove 22 and connected to the connector 4.

Multiple first covers 31 may also be provided with respect to one first storage groove 21 so as to divide the first storage groove 21. Multiple second covers 32 may also be provided with respect to one second storage groove 22 so as to divide the second storage groove 22.

The extension direction of the first storage groove 21 and the second storage grooves 22 need not be the direction in which the battery cells C are arranged side by side. That is, the first storage groove 21 and the second storage groove 22 may also extend in a direction orthogonal to the direction in which the battery cells C are arranged side by side.

The first storage groove 21 and the second storage grooves 22 may also be provided with curving portions or changing widths, so long as they extend in one direction overall. The first storage groove 21 and the second storage grooves 22 may also be portions that are not parallel.

The number of the third storage grooves 23 is not particularly limited, and one, two, three, or more third storage grooves 23 may also be provided. In addition, multiple third storage grooves 23 may also be provided between the first storage groove 21 and one second storage groove 22.

The arrangement of the wires 3 and the wire terminals 2 is not limited to the above-described embodiment. For example, the wires 3 may also be arranged so as to be extended from the second storage grooves 22 to the first storage groove 21 via the third storage grooves 23. The wire terminals 2 may also be arranged side by side in a direction intersecting the extension direction of the first storage groove 21 and the second storage grooves 22. Also, the arrangement of the wire storage grooves 12 and the terminal storage portions 11 is not limited to the above-described embodiment. The wire storage grooves 12 may also be provided in one row in the Y direction. The terminal storage portions 11 may also be provided interposed between the wire storage grooves 12, or in one row. These can be modified as appropriate according to the specification.

The number of battery cells C is not limited to the present embodiment. The numbers of the battery terminals T, the wire terminals 2, and the wires 3 can be modified as appropriate according to the number of the battery cells C.

The battery is not limited to the secondary battery BT.

The battery wiring module 1 is not limited to being mounted on a battery mounted in a vehicle, and can be mounted on batteries mounted in various apparatuses.

### LIST OF REFERENCE NUMERALS

1 Battery wiring module

2 Wire terminal

3 Wire

4 Connector

10 Housing

11 Terminal storage portion

11a Terminal storage portion

11b Terminal storage portion

12 Wire storage groove

21 First storage groove

22 Second storage groove

23 Third storage groove

30 Cover member

31 First cover

32 Second cover

33 Third cover

35 Engaging portion

36 Engaging portion

40 Protruding portion

41 First protruding portion

41a Upper surface

41b Lower surface

41c Inclined surface

42 Second protruding portion

42a Upper surface

42b Lower surface

42c Inclined surface

42d Inclined surface

43 Gap

50 Through hole

60 Rib

121 Bottom wall

121a Opening portion

122 Side wall

B Bus bar

BT Secondary battery

C Battery cell

L Virtual plane

P Part attachment portion

T Battery terminal

What is claimed is:

1. A battery wiring module comprising:
a plurality of wire terminals that are respectively connected to a plurality of bus bars that connect battery terminals of a plurality of battery cells;
a plurality of wires that are respectively connected to the plurality of wire terminals; and
a housing storing the plurality of wire terminals and the plurality of wires,
wherein the housing includes a wire storage groove for storing the wires and a cover member for covering the wire storage groove,
the wire storage groove includes a bottom wall, side walls that stand upright from the bottom wall and oppose each other, and a protruding portion that protrudes from a side wall toward an opposing side wall,
the wire storage groove stores the wires on the bottom wall side relative to the protruding portion inside of the wire storage groove, and
the cover member has a through hole that opposes the protruding portion from a side opposite to the bottom wall.

2. The battery wiring module according to claim 1, wherein
the protruding portion includes a first protruding portion that is provided on one of the side walls that are paired, and a second protruding portion that is provided on the other side wall, and
the first protruding portion and the second protruding portion oppose each other.

3. The battery wiring module according to claim 2, wherein
the first protruding portion protrudes from the side wall past the center between the side walls that are paired.

4. The battery wiring module according to claim 2, wherein
the first protruding portion and the second protruding portion are provided with a gap therebetween.

5. The battery wiring module according to claim 4, wherein
the through hole opposes the first protruding portion, the second protruding portion, and the gap.

6. The battery wiring module according to claim 1, wherein
the protruding portion includes a lower surface that faces the bottom wall side and an upper surface on a side opposite to the lower surface, and
the protruding portion has an inclined surface that is inclined toward the bottom wall side on the upper surface of a distal end portion protruding from the side walls.
